(19) United States
(12) Patent Application Publication
(10) Pub. No.: US 2008/0258545 A1
(43) Pub. Date: Oct. 23, 2008

(54) Brake System for Motor Vehicles

(75) Inventor: Stefan Drumm, Saulheim (DE)

Correspondence Address: CONTINENTAL TEVES, INC., ONE CONTINENTAL DRIVE, AUBURN HILLLS, MI, 48326-1581, US

(73) Assignee: Continental Teves AG & Co. oHG

(21) Appl. No.: 11/664,635

(22) PCT Filed: Oct. 13, 2005
(86) PCT No.: PCT/EP2005/055244

§ 371 Date: Feb. 28, 2008

(30) Foreign Application Priority Data
Oct. 15, 2004 (DE) 10 2004 050 112.2
Aug. 4, 2005 (DE) 10 2005 036 638.4

(51) Int. Cl. B60T 8/44

(52) U.S. Cl. 303/114.1

(57) ABSTRACT

A brake system for motor vehicles has a master cylinder (1) to which wheel brake cylinders are connectable, a first piston (2) which is coupled to a brake pedal (3) by way of a push rod (28) that transmits actuating forces, a second piston (4) used to actuate the master cylinder (1), a third piston (5) which can be actuated by the first piston (2) and can be moved into a force-transmitting connection with the second piston (4), a pedal travel simulator, a coupling element between the first and the third pistons, which is activated depending on the displacement travel of the third piston (5), with a space (11) between the second (4) and the third pistons (5) with the pressurization of the space (11) loading the second and third pistons (4, 5) in opposite directions, as well as with a pressure-supplying module (13), which enables both filling of the space (11) with pressure fluid as well as its evacuation.

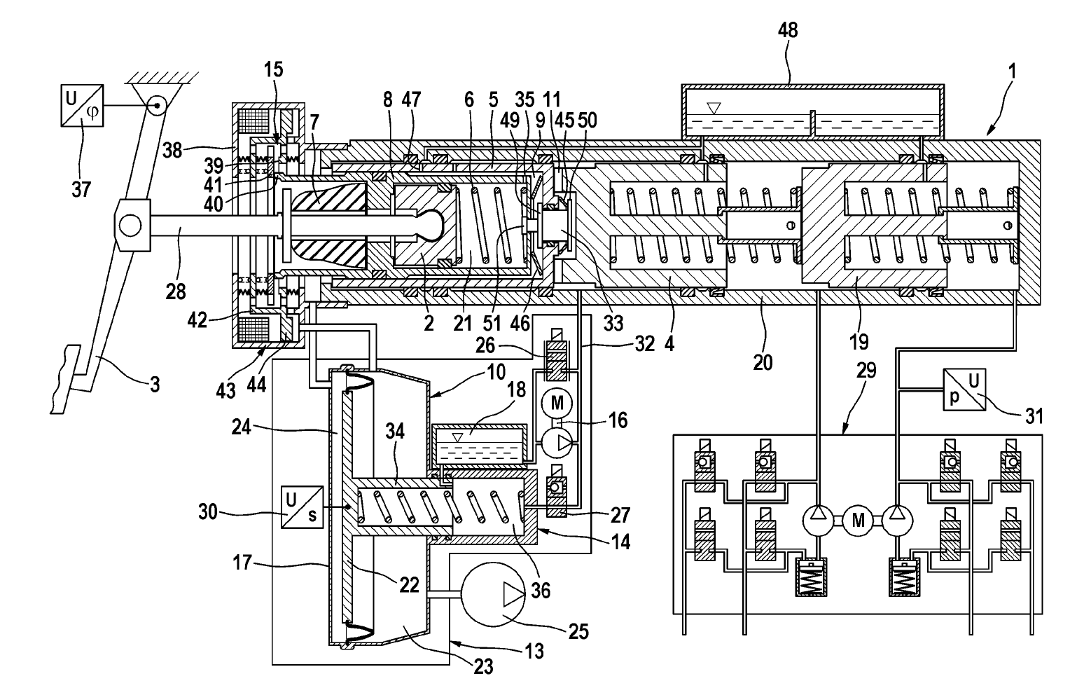

### BACKGROUND OF THE INVENTION

The present invention relates to a brake system for motor vehicles comprising a master cylinder to which wheel brake cylinders are connectable, a first piston which is coupled to a brake pedal by way of a push rod that transmits actuating forces, a second piston which actuates the master cylinder, a third piston which can be actuated by the first piston and is movable into a force-transmitting connection with the second piston, with at least one elastic element forming a pedal travel simulator that imparts a pleasant pedal feeling to the operator in a ‘brake-by-wire’ operating mode, with a means to couple the movements of the first piston and the third piston being activated depending on the displacement travel of the third piston in a housing, with a space between the second and the third pistons to which hydraulic pressure is applicable, wherein a pressurization of the space loads the second and the third pistons in opposite directions, as well as a pressure supplying module, which allows both filling the space with pressure fluid and evacuating it.

‘Brake-by-wire’ brake systems are employed in motor vehicle technology at an increasing rate. In the brake systems, the brake can be actuated ‘independently’ in response to electronic signals without any action on the part of the driver. The electronic signals can be output by an electronic stability program ESP or a collision avoidance system ACC, for example. When an independent actuation of this type is superposed on an actuation by the driver, the driver of the motor vehicle notices a reaction in the brake pedal. This reactive effect on the brake pedal can be surprising and unpleasant for the driver so that, in a critical situation in traffic, the driver will not apply the brake pedal to an extent that complies with this situation because the reaction to the brake pedal that is due to the independent actuation of the brake is irritating him.

DE 10 2004 025 638 A1 discloses a brake system of the type mentioned hereinabove. An ‘independent actuation’ of the prior-art brake system or pressurization of the space is executed by the pressure-supplying module using an electrically operable valve device in the ‘brake-by-wire’ operating mode. The fact is considered disadvantageous in the prior-art brake system that boosting of the actuating force generated by the operator is possible only when the electronic unit and the energy supply (generator, battery, and electrical wiring system) provided in the vehicle are intact.

In view of the above, an object of the invention is to disclose a brake system of the type initially referred to, wherein the actuating force is boosted even if the electronic control unit or the electric energy supply fail, while the pedal feeling shall remain constant under all conditions, except for a fallback mode that is necessary for the reliable operation.

### SUMMARY OF THE INVENTION

According to the invention, this object is achieved in that the pressure-supplying module is designed as a piston-and-cylinder assembly that is operable by means of a pneumatic actuator, and in that the pneumatic actuator is operable by means of a control valve, which is operable independently both by the brake pedal and irrespective of the brake pedal.

A motor-and-pump assembly that can be connected to the piston-and-cylinder assembly is provided in a favorable improvement of the invention. It is achieved by this provision that the pressure introduced into the space can be increased further.

In another favorable embodiment of the subject matter of the invention, the pneumatic actuator includes a housing, having its interior subdivided by a movable wall into a vacuum chamber and a working chamber, which can be acted upon by a vacuum or the atmospheric pressure by means of the control valve.

One embodiment of the invention will be explained in detail in the following text by making reference to the accompanying schematic drawing.

### BRIEF DESCRIPTION OF THE DRAWING

The only FIGURE shows the design of the brake system of the invention.

### DETAILED DESCRIPTION OF THE DRAWING

The brake system of the invention as illustrated in the drawing includes a brake pedal 3, which is connected to a first piston 2 by way of an operating rod 28 in terms of effect. The brake pedal travel can be sensed using a sensor 37 for determining the angle of rotation. The first piston 2 is arranged in a fourth piston 8, and a simulator chamber 21 is provided between the first and the fourth piston 8 in which a compression spring 6 is arranged, moving the first piston 2 into abutment on the fourth piston 8 when the pedal is not applied. The fourth piston 8 is displaceably guided in a third piston 5 and delimits in the latter a hydraulic compartment 9, which is in communication via a passage 35 with the simulator chamber 21 and via an additional passage 47 with an unpressurized pressure fluid supply tank 48. A movement of the third piston 5 relative to the housing 20 shuts off the additional passage 47. An elastic element 7, e.g. an elastomeric spring, is interposed between the operating rod 28 and the fourth piston 8 in terms of effect and, along with the spring 6, forms a pedal travel simulator, that imparts the customary pedal feeling to the operator when the brake system is activated, which corresponds to a usual brake pedal characteristics. This implies that the resistance rises slowly with a small brake pedal travel and increases overproportionally when the brake pedal travel is larger. The above-mentioned compression spring 6 could just as well be arranged in a ‘dry’ fashion, i.e. outside the simulator chamber 21, e.g. in parallel to the elastomeric spring 7.

In addition, a second piston 4 is provided, which represents an operating piston of a master brake cylinder 1. In the example shown, the master brake cylinder 1 is configured as a tandem master cylinder wherein an additional piston 19 is connected downstream of the second piston 4. The wheel brakes of the vehicles are connected to the master brake cylinder 1 by way of a controllable wheel brake pressure modulation module 29, and a pressure sensor 31 is provided to sense the hydraulic pressure introduced into the master cylinder 1. Of course, further pressure sensors can be employed, for example, to sense the individual wheel brake pressures.

All pistons 2, 4, 5, 8, 19 are accommodated in a housing 20, with the second piston 4, the third piston 5, and the additional piston 19 of the master cylinder having the same diameter or identical cross-sectional surfaces in the illustrated design. A space 11 exists between the third piston 5 and the second piston 4, with the third piston 5 including an aperture between the space 11 and the hydraulic chamber 9, in which a fifth piston 33 is arranged in a hydraulically sealed and axially displaceable manner, the relative movement of said piston vis-à-vis the third piston 5 being limited by stops 49 and 50, respectively, that act in or in opposition to the actuating direction. Between the stop 50 that acts in opposition to the actuating direction and the end surface of the third piston 5 that faces the space 11, a spring 45 biasing the fifth piston 33 in the actuating direction is provided, while a second spring 46 acts between the third piston 5 and the fourth piston 8. A third stop 51 provided at the fifth piston 33 limits the movement of the fourth piston 8 relative to the third piston 5. A hydraulic connection 32 connects the space 11 to a pressure-supplying module 13 that allows pressurization of the space.

The pressure-supplying module 13 is essentially composed of a piston-and-cylinder assembly 14, which is operable by means of a pneumatic actuator 10 and to which a motor-and-pump assembly 16 is connected. A pressure fluid supply tank 18 is connected both to the pneumatic actuator 10 and to the suction side of the motor-and-pump assembly 16. A hose coupling to the pressure fluid supply tank 48 can be used instead of the illustrated tank associated with the pressure-supplying module. The pneumatic actuator 10 has an actuator housing 17, in which a vacuum chamber 23 connected to a vacuum pump 29 or an equivalent air suction device, as well as a ventilatable working chamber 24 are isolated from one another by a movable wall 22. The movable wall 22 is in a force-transmitting connection with the piston 34 (shown only schematically) of the piston-and-cylinder assembly 14, with the above-mentioned line 32 being connected to the pressure chamber 36 of the said assembly. On the other hand, the pressure chamber 36 is in communication with the unpressurized pressure fluid supply tank 18 by way of a closable connection. Connected in parallel to the motor-and-pump assembly 16 is an analog controllable, electromagnetically operable two-way/two-position directional control valve 26, which is used to accurately adjust the pressure supplied by the motor-and-pump assembly 16.

Besides, a likewise electromagnetically operable, normally open two-way/two-position directional control valve 27 is inserted into the hydraulic connection 32 between the space 11 and the electrohydraulic pressure-supplying module 13, which valve performs the function of a non-return valve closing towards the piston-and cylinder assembly 14 when in its ‘energized’ switching position.

A control valve is used to actuate the pneumatic actuator 10, which valve is designated by reference numeral 15 and is arranged in a control valve housing 38 that is fastened at the master cylinder housing 20 in the inlet area thereof. The control valve 15 is composed of a first seat, i.e. a vacuum sealing seat 39, a second seat, i.e. an atmospheric sealing seat 40, and an annular valve member 41 that cooperates with the sealing seats 39, 40. The atmospheric sealing seat 40 is preferably designed at the end of the fourth piston 8 close to the brake pedal 3, while the vacuum sealing seat 39 is provided on a ring 42. Further, the control valve housing 38 houses an electric actuator, e.g. an electromagnet 43, whose armature is connected to the ring 42 or is of integral designed therewith, and which allows an independent actuation of the control valve 15 irrespective of the brake pedal 3.

The above-mentioned simulator chamber 21 arranged in the fourth piston 8 is a component part of a hydraulic shut-off device for coupling the movements of the first piston (2) and the third piston (5) or the fourth piston 8, respectively, which is activated depending on the displacement travel of the third piston 5 in the master cylinder housing 20. For this purpose, a hydraulic connection is established between the simulator chamber 21 and the pressure fluid supply tank 48 associated with the master brake cylinder 1, the said connection leading via the passage 35 in the third piston 5 to a section of the hydraulic compartment 9, which opens into the simulator chamber 21 and is provided in the fourth piston 8. Upon application of the brake pedal, initially the fourth piston 8 displaces in the third piston 5 due to an appropriate spring arrangement. This causes the vacuum sealing seat 39 to close and the atmospheric sealing seat 40 to open, with the result that the working chamber 24 of the pneumatic actuator 10 in the pressure-supplying module 13 is ventilated and the resulting effect of force on the movable wall 22 actuates the piston 34 of the piston-and-cylinder assembly 14. The so produced hydraulic pressure in the pressure chamber 36 is delivered through the hydraulic connection 32 to the space 11 in the master cylinder housing 20. Thus, the master brake cylinder 1 is actuated, on the one hand, and the third piston 5 is pressed against a stop on the housing, on the other hand, whereby the passage 35 stays open and the pedal travel simulator operable. With insufficient or lacking booster pressure in the space 11, the third piston 5 displaces in the master cylinder housing 20, with the result that the passage 35 closes and the pedal travel simulator is disabled, because the movement of the third piston 5 is coupled hydraulically to the movement of the first piston 2. In this arrangement, the hydraulic connections comprised in the shut-off device can serve as hydraulic throttling elements for hydraulically damping the pedal travel simulator 6, 7, and at least one of the hydraulic throttling elements can exhibit a performance that depends on the direction of flow.

The brake system of the invention can operate in different modes of operation. In a non-actuated condition, the same pressure prevails in both chambers 23, 24 of the pneumatic actuator 10 because the vacuum sealing seat 39 is open.

In a purely electrically controlled operating mode, the control valve 15 is actuated by way of the electromechanical actuator 43 in order to ventilate the working chamber 24 of the pneumatic actuator 10. As this occurs, the above-mentioned vacuum sealing seat 39 is closed and the atmospheric sealing seat 40 opened. Due to the effect of force of the introduced air at the movable wall 22, hydraulic pressure develops in the pressure chamber 36 of the piston-and-cylinder assembly 14 and is supplied to the space 11 via the open two-way/two-position directional control valve 27 and the line 32. This pressure causes the second piston (4) and the additional piston 19 of the master cylinder 1 to displace to the right, as viewed in the drawing, so that pressure fluid flows into both brake circuits (only indicated). When higher pressure is required in space 11 than the pneumatic actuator 10 is able to supply with the instantaneously available vacuum, the motor-and-pump assembly 16 can support the pressure buildup in the space 11.

In a first pedal-controlled operating mode, application of the brake pedal 3 brings about a mechanical actuation of the control valve 15, having the effect explained above as a result. Of course, a combined operating mode with a simultaneous pedal-controlled and electric actuation of the control valve 15 is also possible. This mode is employed, for example, in order to achieve the function of the brake assist system, which is well known to the one skilled in brake technology, which consists in that defined brake-pedal-controlled brake operations are accelerated and intensified.

In another operating mode, which corresponds to a fallback mode, hydraulic pressure cannot build up in the space 11 due to a disturbance in the sequences described hereinabove, with the result that force transmission from the third piston 5 to the second piston 4 occurs by direct contact. The master brake cylinder 1 is actuated exclusively by using muscle power.

The invention allows achieving a brake system of a simple design, in which the brake pedal characteristics does not depend on the actuating condition of the remaining brake system, with the result that in the event of a brake operation by the driver, the pedal feeling can neither be disturbed by the simultaneous existence of an independent brake operation, nor by any other control activities of the brake system such as anti-lock control, traction control, or driving stability control.

The additional advantage of the brake system can be seen in its simpler design compared to conventional brake systems. Vehicles equipped with an electronic stability control function (ESP) e.g. require a special ESP hydraulics, which is more complicated than a normal ABS hydraulics because it must also inhere the ability of building up wheel brake pressures in excess of the master cylinder pressure, what is in contrast to the ABS hydraulics. In contrast thereto, the brake system disclosed manages with a simple ‘ABS’ hydraulic module containing only eight solenoid valves on the side connected downstream of the master cylinder.

1.-23. (canceled)

24. A brake system for motor vehicles comprising
a master cylinder (1) to which wheel brake cylinders are connectable,
a first piston (2) which is coupled to a brake pedal (3) by way of a push rod (28) that transmits actuating forces,
a second piston (4) for actuating the master cylinder (1),
a third piston (5) which can be actuated by the first piston (2) and can be moved into a force-transmitting connection with the second piston (4),
at least one elastic element (6, 7) forming a pedal travel simulator,
a coupling element for coupling the movements of the first and the third pistons, which coupling element is activated depending on the displacement travel of the third piston (5) in a housing (20),
a space (11) between the second (4) and the third pistons (5) to which hydraulic pressure is applicable, and pressurization of the space (11) loads the second and third pistons (4, 5) in opposite direction,
as well as a pressure-supplying module (13), which enables both filling of the space (11) with pressure fluid as well as its evacuation,
wherein the pressure-supplying module (13) is designed as a piston-and-cylinder assembly (14) with a pneumatic actuator (10), and wherein the pneumatic actuator (10) is operable by means of a first control valve (15), which is operable both by the brake pedal (3) and irrespective of a brake pedal (3) actuation.

25. The brake system as claimed in claim 24
with a motor-and-pump assembly (16), which can be connected to the piston-and-cylinder assembly (14).

26. The brake system as claimed in claim 25,
wherein connected in parallel to the motor-and-pump assembly (16) is an analog controllable, normally closed two-way/two-position directional second control valve (26).

27. The brake system as claimed in claim 26,
wherein a sensor, preferably a sensor for determining an angle of rotation (37), is provided to detect the brake pedal position and movement, generating an output signal, which is sent to an electronic control unit and serves to actuate the first control valve (15), the motor-and-pump assembly (16), and the two-way/two-position directional control valves (26, 27).

28. The brake system as claimed in claim 24,
wherein the pneumatic actuator (10) includes a housing (17), having its interior subdivided by a movable wall (22) into a vacuum chamber (23) and a working chamber (24), which can be acted upon by a vacuum or the atmospheric pressure by means of the first control valve (15).

29. The brake system as claimed in claim 28,
wherein the vacuum chamber (23) can be connected to a vacuum pump (25).

30. The brake system as claimed in claim 28,
wherein a travel sensor (30) is provided to sense the movement of the movable wall (22).

31. The brake system as claimed in claim 24,
wherein an electrically operable, normally open two-way/two-position directional control valve (27) is interposed between the cylinder-and-piston assembly (14) and the space (11), which valve performs the function of a non-return valve closing towards the piston-and-cylinder assembly (14) when in its activated switching position.

32. The brake system as claimed in claim 24,
wherein between the first piston (2) and the third piston (5), a fourth piston (8) is arranged, on which elastic elements (6, 7) of the pedal travel simulator take support.

33. The brake system as claimed in claim 32,
wherein the fourth piston (8) includes a passage (35) allowing a simulator chamber (21) delimited by the first piston (2) and fourth piston (8) to communicate with a hydraulic compartment (9) delimited by the fourth piston (8) and third piston (5).

34. The brake system as claimed in claim 32,
wherein the third piston (5) includes a passage (35) between the hydraulic compartment (9) and the space (11), in which a fifth piston (33) is arranged in a hydraulically sealed and axially displaceable manner, the movement of said piston being limited by stops (49, 50) cooperating with the third piston (5), one (49) of the stops acting in the actuating direction and the other (50) one in opposition to the actuating direction.

35. The brake system as claimed in claim 34,
wherein a compression spring (45) is interposed between the fifth piston (33) and the third piston (5) and, when the space (11) is unpressurized, moves the stop (49) that acts in the actuating direction into abutment on the third piston (5).

36. The brake system as claimed in claim 35,
wherein a movement of the fourth piston (8) relative to the fifth piston (33), which is guided in the third piston (5), after a defined actuating travel, causes abutment of the fourth piston (8) on the fifth piston (33) so that a force-transmitting connection is established between the fourth piston (8) and the fifth piston (33).

37. The brake system as claimed in claim 35,
wherein a movement of the fourth piston (8) in the third piston (5) in opposition to the actuating direction is limited by a stop (51) at the fifth piston (33) or a stop on the third piston (5).

38. The brake system as claimed in claim 37,
wherein a compression spring (46) is arranged between the third piston (5) and the fourth piston (8), moving the fourth piston (8) into abutment on the stop (51) when the brake pedal is not applied.

39. The brake system as claimed in claim 32,
wherein the first control valve (15) is designed in a control valve housing (38) arranged in the inlet area of the master cylinder housing (20) and is composed of a vacuum sealing seat (39), an atmospheric sealing seat (40), and a valve member (41), with the vacuum sealing seat (39) being designed at an axially movable ring (42) guided in the control valve housing (38) and provided with pneumatic passages, and the atmospheric sealing seat (40) being designed on the fourth piston (8).

40. The brake system as claimed in claim 24,
wherein the independent actuation of the first control valve (15) takes place by means of an electromechanical actuator, preferably an electromagnet (43), whose armature (44) is connected to the ring (42).

41. The brake system as claimed in claim 24,
wherein a hydraulic shut-off device is provided to couple the movements of the first piston (2) and the third piston (5), being activated depending on the displacement travel of the third piston (5) in the housing (20).

42. The brake system as claimed in claim 41,
wherein the shut-off device is formed of a simulator chamber (21) delimited by the fourth piston (8) and the first piston (2), the compartment (9) and a closable hydraulic connection between the compartment (9) and the pressure fluid supply tank (48).

43. The brake system as claimed in claim 42,
wherein hydraulic connections contained in the shut-off device serve as hydraulic throttling elements of the pedal travel simulator (6, 7).

44. The brake system as claimed in claim 43,
wherein at least one of the hydraulic throttling elements exhibits a performance that depends on the direction of flow.

45. The brake system as claimed in claim 43,
wherein the motor-and-pump assembly (16), the second control valve (26), and the wheel brake pressure modulation module (29) form a construction unit.

46. The brake system as claimed in claim 24,
wherein the wheel brake cylinders are connected to the master cylinder (1) by means of a wheel brake pressure modulation module (29).
